(19) United States
(12) Patent Application Publication
(10) Pub. No.: US 2020/0387633 A1
(43) Pub. Date: Dec. 10, 2020

(54) APPARATUS, METHOD, AND PROGRAM PRODUCT FOR SECURING PERSONAL INFORMATION IN A FILE

(71) Applicant: LENOVO (Singapore) PTE. LTD., New Tech Park (SG)

(72) Inventors: Robert James Kapinos, Durham, NC (US); Scott Wentao Li, Cary, NC (US); Robert James Norton, JR., Raleigh, NC (US); Russell Speight VanBlon, Raleigh, NC (US)

(21) Appl. No.: 16/434,873

(22) Filed: Jun. 7, 2019

(51) Int. Cl. G06F 21/62; G06F 16/16

(52) U.S. Cl. CPC G06F 21/6254; G06F 16/162

(57) ABSTRACT

Apparatuses, methods, and program products are disclosed for securing personal information in a file. One apparatus includes a processor and a memory that stores code executable by the processor. The code is executable by the processor to detect, by use of the processor, that a file is deleted. The code is executable by the processor to, in response to detecting that the file is deleted, determine whether the file likely contains personally identifiable information. The code is executable by the processor to, in response to determining that the file likely contains personally identifiable information, modify the file to secure the personally identifiable information.

### FIELD

The subject matter disclosed herein relates to security and more particularly relates to securing personal information in a file.

### BACKGROUND

### Description of the Related Art

Information handling devices, such as desktop computers, laptop computers, tablet computers, smart phones, optical head-mounted display units, smart watches, televisions, streaming devices, etc., are ubiquitous in society. These information handling devices may be used for performing various actions. Files may be stored by an information handling device. The files may include personally identifiable information. Upon deletion of the files, the personally identifiable information may be unsecure.

### BRIEF SUMMARY

An apparatus for securing personal information in a file is disclosed. A method and computer program product also perform the functions of the apparatus. In one embodiment, the apparatus includes a processor and a memory that stores code executable by the processor. The code, in various embodiments, is executable by the processor to detect, by use of the processor, that a file is deleted. The code, in certain embodiments, is executable by the processor to, in response to detecting that the file is deleted, determine whether the file likely contains personally identifiable information. The code, in some embodiments, is executable by the processor to, in response to determining that the file likely contains personally identifiable information, modify the file to secure the personally identifiable information.

In some embodiments, the file is deleted by moving the file to a recoverable location. In one embodiment, the code executable by the processor, in response to determining that the file likely contains personally identifiable information, permanently deletes the file so that the file is unrecoverable. In various embodiments, the code executable by the processor modifies the file to secure the personally identifiable information by replacing the personally identifiable information with non-personally identifiable information. In some embodiments, the code executable by the processor determines whether the file likely contains personally identifiable information by searching the file for data resembling personally identifiable information.

A method for securing personal information in a file, in one embodiment, includes detecting, by use of a processor, that a file is deleted. In certain embodiments, the method includes, in response to detecting that the file is deleted, determining whether the file likely contains personally identifiable information. In some embodiments, the method includes, in response to determining that the file likely contains personally identifiable information, modifying the file to secure the personally identifiable information.

In some embodiments, the file is a computer file. In various embodiments, the file is deleted by moving the file to a recoverable location. In one embodiment, the file is deleted by permanently deleting the file. In some embodiments, the personally identifiable information includes information usable to identify a person. In certain embodiments, modifying the file to secure the personally identifiable information includes encrypting at least a portion of the file.

In some embodiments, modifying the file to secure the personally identifiable information includes replacing the personally identifiable information with non-personally identifiable information. In various embodiments, the non-personally identifiable information includes empty values. In certain embodiments, the non-personally identifiable information includes reference data that facilitates restoring the personally identifiable information into the file.

In various embodiments, modifying the file to secure the personally identifiable information includes overwriting the file with data to make the file unrecoverable. In certain embodiments, determining whether the file likely contains personally identifiable information includes searching the file for data resembling personally identifiable information.

In one embodiment, a program product includes a computer readable storage medium that stores code executable by a processor. The executable code, in certain embodiments, includes code to perform detecting, by use of the processor, that a file is deleted. The executable code, in various embodiments, includes code to perform, in response to detecting that the file is deleted, determining whether the file likely contains personally identifiable information. The executable code, in some embodiments, includes code to perform, in response to determining that the file likely contains personally identifiable information, modifying the file to secure the personally identifiable information.

In certain embodiments, the executable code further includes code to perform modifying the file to secure the personally identifiable information by encrypting at least a portion of the file. In one embodiment, the executable code further includes code to perform modifying the file to secure the personally identifiable information by replacing the personally identifiable information with non-personally identifiable information. In certain embodiments, the executable code further includes code to perform, in response to determining that the file likely contains personally identifiable information, permanently deleting the file so that the file is unrecoverable.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for securing personal information in a file;

FIG. 2 is a schematic block diagram illustrating one embodiment of an apparatus including an information handling device;

FIG. 3 is a schematic block diagram illustrating one embodiment of an apparatus including a file handling module;

FIG. 4 is a schematic block diagram illustrating another embodiment of an apparatus including a file handling module;

FIG. 5 is a schematic flow chart diagram illustrating an embodiment of a method for securing personal information in a file; and

FIG. 6 is a schematic flow chart diagram illustrating another embodiment of a method for securing personal information in a file.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

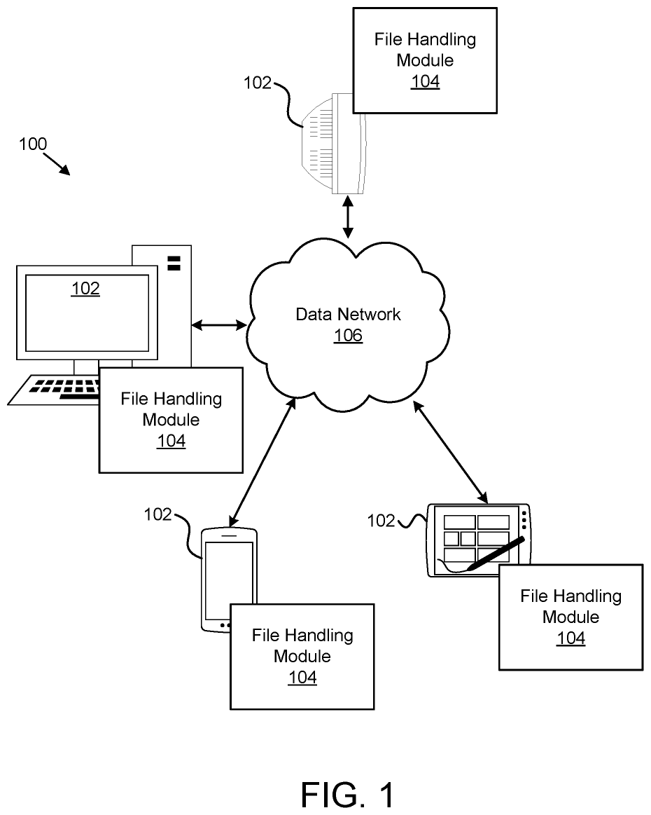

FIG. 1 depicts one embodiment of a system 100 for securing personal information in a file. In one embodiment, the system 100 includes information handling devices 102, file handling modules 104, and data networks 106. Even though a specific number of information handling devices 102, file handling modules 104, and data networks 106 are depicted in FIG. 1, one of skill in the art will recognize that any number of information handling devices 102, file handling modules 104, and data networks 106 may be included in the system 100.

In one embodiment, the information handling devices 102 include computing devices, such as desktop computers, laptop computers, personal digital assistants (PDAs), tablet computers, smart phones, cellular phones, smart televisions (e.g., televisions connected to the Internet), set-top boxes, game consoles, security systems (including security cameras), vehicle on-board computers, network devices (e.g., routers, switches, modems), streaming devices, or the like. In some embodiments, the information handling devices 102 include wearable devices, such as smart watches, fitness bands, optical head-mounted displays, or the like. The information handling devices 102 may access the data network 106 directly using a network connection.

The information handling devices 102 may include an embodiment of the file handling module 104. In certain embodiments, the file handling module 104 may detect, by use of the processor, that a file is deleted. The file handling module 104 may also, in response to detecting that the file is deleted, determine whether the file likely contains personally identifiable information. The file handling module 104 may, in response to determining that the file likely contains personally identifiable information, modify the file to secure the personally identifiable information. In this manner, the file handling module 104 may be used for securing personal information in a file.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a WAN, a storage area network (“SAN”), a LAN, an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, RAM, or the like.

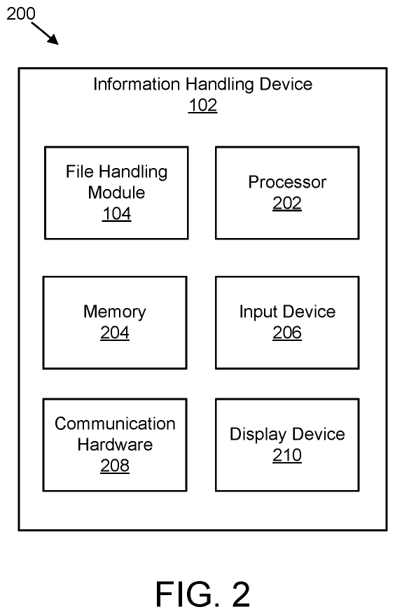

FIG. 2 depicts one embodiment of an apparatus 200 that may be used for securing personal information in a file. The apparatus 200 includes one embodiment of the information handling device 102. Furthermore, the information handling device 102 may include the file handling module 104, a processor 202, a memory 204, an input device 206, communication hardware 208, and a display device 210. In some embodiments, the input device 206 and the display device 210 are combined into a single device, such as a touchscreen.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the file handling module 104, the input device 206, the communication hardware 208, and the display device 210.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media.

In some embodiments, the memory 204 stores file and/or data relating to file handling. In some embodiments, the memory 204 also stores program code and related data, such as an operating system or other controller algorithms operating on the information handling device 102.

The information handling device 102 may use the file handling module 104 for securing personal information in a file. As may be appreciated, the file handling module 104 may include computer hardware, computer software, or a combination of both computer hardware and computer software. For example, the file handling module 104 may include circuitry, or a processor, used to detect, by use of the processor 202, that a file is deleted. As another example, the file handling module 104 may include computer program code that, in response to detecting that the file is deleted, determines whether the file likely contains personally identifiable information. As a further example, the file handling module 104 may include computer program code that, in response to determining that the file likely contains personally identifiable information, modifies the file to secure the personally identifiable information.

The input device 206, in one embodiment, may include any known computer input device including a touch panel, a button, a keyboard, a stylus, or the like. In some embodiments, the input device 206 may be integrated with the display device 210, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel. The communication hardware 208 may facilitate communication with other devices. For example, the communication hardware 208 may enable communication via Bluetooth®, Wi-Fi, and so forth.

The display device 210, in one embodiment, may include any known electronically controllable display or display device. The display device 210 may be designed to output visual, audible, and/or haptic signals. In some embodiments, the display device 210 includes an electronic display capable of outputting visual data to a user. For example, the display device 210 may include, but is not limited to, an LCD display, an LED display, an OLED display, a projector, or similar display device capable of outputting images, text, or the like to a user. As another, non-limiting, example, the display device 210 may include a wearable display such as a smart watch, smart glasses, a heads-up display, or the like. Further, the display device 210 may be a component of a smart phone, a personal digital assistant, a television, a table computer, a notebook (laptop) computer, a personal computer, a vehicle dashboard, a streaming device, or the like.

In certain embodiments, the display device 210 includes one or more speakers for producing sound. For example, the display device 210 may produce an audible alert or notification (e.g., a beep or chime). In some embodiments, the display device 210 includes one or more haptic devices for producing vibrations, motion, or other haptic feedback. For example, the display device 210 may produce haptic feedback upon performing an action.

In some embodiments, all or portions of the display device 210 may be integrated with the input device 206. For example, the input device 206 and display device 210 may form a touchscreen or similar touch-sensitive display. In other embodiments, the display device 210 may be located near the input device 206. In certain embodiments, the display device 210 may receive instructions and/or data for output from the processor 202 and/or the file handling module 104.

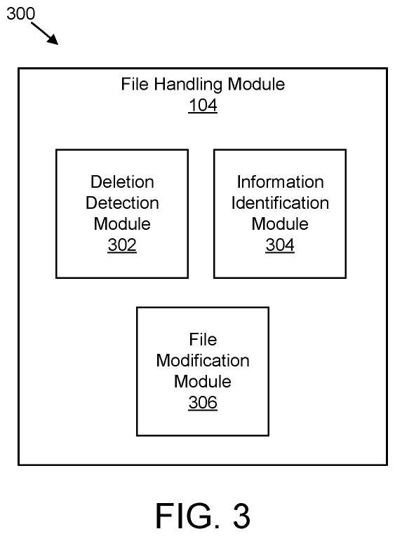

FIG. 3 depicts a schematic block diagram illustrating one embodiment of an apparatus 300 that includes one embodiment of the file handling module 104. Furthermore, the file handling module 104 includes a deletion detection module 302, an information identification module 304, and a file modification module 306.

In certain embodiments, the deletion detection module 302 may detect, by use of the processor, that a file is deleted. As may be appreciated, the file may be a computer file that includes a collection of data, a program, a database, a document, a batch of data, or so forth. The file may be stored in the memory 204 under a single identifying name. In some embodiments, the deletion detection module 302 may monitor a file system and/or operating system in real-time to detect (e.g., via an interrupt) that a file is deleted at a time at which a user selects to delete a file (e.g., detect a file deletion command). In other embodiments, the deletion detection module 302 may detect that a file is deleted by running an automated process at a predetermined interval (e.g., every 5 minutes, every hour, once per day, etc.). The automated process may detect any files that have been deleted since the last time the automated process was run.

In certain embodiments, files that have been detected as deleted may be tagged by adding an indication to the files and/or by storing information in a database that indicates deleted files that have been previously detected. The tagging may occur immediately upon detection that the file is deleted and/or after the file is modified as described herein. As may be appreciated, a file may be temporarily deleted by a user, or permanently deleted by a user. A temporarily deleted file may be deleted by moving the file to a recoverable location (e.g., a recycle bin, a trash, etc.). The temporarily deleted file may be restored upon selection (e.g., recoverable) by a user of an operating system. A permanently deleted file may be permanently deleted by removing a mapping between the operating system and the file (e.g., removing a reference to the file from a master file table) and making the memory locations occupied by the file overwritable by the operating system. However, a permanently deleted file may still be recoverable if the file has not been overwritten (e.g., by recreating the mapping between the operating system and the file).

In one embodiment, the information identification module 304 may, in response to detecting that the file is deleted, determine whether the file likely contains personally identifiable information. Personally identifiable information (“PII”) may include any information usable to identify a person. For example, personally identifiable information may include a name, a phone number, an email address, a social security number, a credit card number, account information, a password, an address, a fingerprint, a code, and so forth. As used herein, the term personally identifiable information may refer to actual personally identifiable information, information that is likely to be personally identifiable information, information that is similar to personally identifiable information, information that is treated like personally identifiable information, and/or information that is detected as likely to be personally identifiable information.

In certain embodiments, determining whether a file likely contains personally identifiable information includes searching the file for data resembling personally identifiable information. In some embodiments, the file may be searched using a cursory fuzzy string format based search, an artificial intelligence based search, a mathematically optimized search, a heuristic based search, and so forth. The search may detect any information in the file that resembles and/or is closely related to personally identifiable information (e.g., information likely to be PII). As may be appreciated, false positive identification of personally identifiable information is okay because it is better to be overinclusive and include some information that is not personally identifiable information than to miss information that actually is personally identifiable information. In other words, the search is designed to have a high probability of capturing personally identifiable information even though some information that is detected will not be personally identifiable information. In addition to determining whether the file likely contains personally identifiable information, specific locations within the file that likely contain personally identifiable information may be detected, determined, tagged, and/or identified.

In various embodiments, the file modification module 306 may, in response to determining that the file likely contains personally identifiable information, modify the file to secure the personally identifiable information. In some embodiments, modifying the file to secure the personally identifiable information includes encrypting at least a portion of the file. In certain embodiments, modifying the file to secure the personally identifiable information includes replacing the personally identifiable information with non-personally identifiable information. In various embodiments, the non-personally identifiable information may include empty values. In some embodiments, the non-personally identifiable information includes reference data that facilitates restoring the personally identifiable information into the file. In certain embodiments, modifying the file to secure the personally identifiable information includes overwriting the file with data to make the file unrecoverable. In some embodiments, the file modification module 306 may, in response to determining that the file likely contains personally identifiable information, permanently delete the file so that the file is unrecoverable.

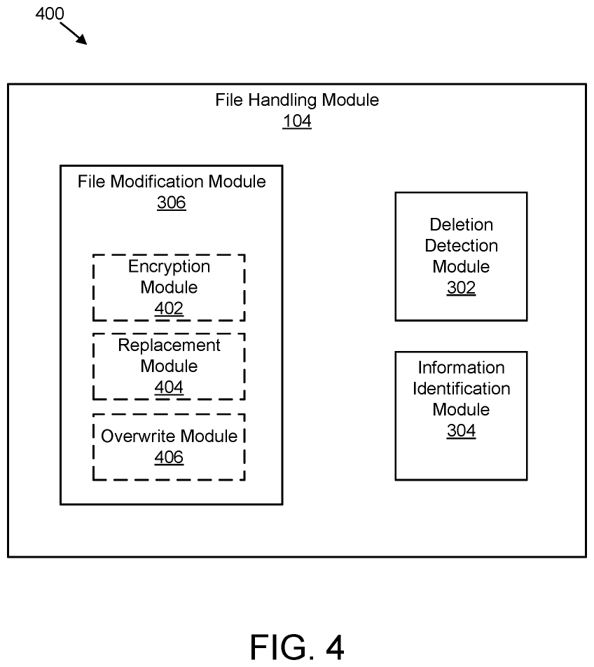

FIG. 4 is a schematic block diagram illustrating another embodiment of an apparatus 400 that includes one embodiment of the file handling module 104. Furthermore, the file handling module 104 includes one embodiment of the deletion detection module 302, the information identification module 304, and the file modification module 306, that may be substantially similar to the deletion detection module 302, the information identification module 304, and the file modification module 306 described in relation to FIG. 3. The file modification module 302 optionally includes an encryption module 402, a replacement module 404, and/or an overwrite module 406.

The encryption module 402 may modify the file to secure the personally identifiable information by encrypting at least a portion of the file. In one embodiment, the file handling module 104 may prompt a user for a password to use to encrypt the entire file. The user may select a universal password for encrypting all files, or the user may select a password for each file as it is encrypted. In some embodiments, the encryption module 402 may only encrypt personally identifiable information within a file. In certain embodiments, an encryption key (e.g., hardware secret device key, software key, user related key) may be used to encrypt either the file or personally identifiable information within the file.

The encryption key may be the same for each file and/or each item of personally identifiable information or the encryption key may be different for each file and/or each item of personally identifiable information. Any file and/or item of personally identifiable information that is encrypted may be tagged with a flag (e.g., an eyecatcher flag, an identifier, an encryption notification, etc.). Accordingly, if the file that is encrypted and/or the file having the item of personally identifiable information that is encrypted is selected (e.g., staged) to be undeleted, the file may be searched for the flag to determine whether there is an encryption that should be removed as the file is undeleted. The encryption key used to encrypt the file and/or the item of personally identifiable information may be used to unencrypt the file and/or the item of personally identifiable information. As may be appreciated, individuals trying to decrypt the file and/or the item of personally identifiable information may be unable to perform the decryption because the individuals do not have access to the encryption key (e.g., system hardware key, etc.).

The replacement module 404 may modify the file to secure the personally identifiable information by replacing the personally identifiable information with non-personally identifiable information. In some embodiments, the non-personally identifiable information includes empty values, a pattern, and/or dummy data. Accordingly, the replacement module 404 may replace any personally identifiable information with empty values (e.g., zero values), a predetermined pattern (e.g., alternating ones and zeros, high values, one values), and/or dummy data (e.g., randomized ones and zeros). As may be appreciated, by replacing the personally identifiable information with empty values, a predetermine pattern, and/or dummy data, the personally identifiable information may be permanently lost from the file so that if the file is restored, the personally identifiable information may not be restored.

In various embodiments, the non-personally identifiable information includes reference data that facilitates restoring the personally identifiable information into the file. In conjunction with the non-personally identifiable information replacing the personally identifiable information, the personally identifiable information is copied to a different file, a database, and/or a memory location. The non-personally identifiable information may be reference data used to identify where the personally identifiable information taken out of the file is found within the different file, the database, and/or the memory location. In some embodiments, the non-personally identifiable information may include a code, a reference value, an index to a table, a memory location, or so forth. If the deleted file is to be restored, the reference data may be used to put the personally identifiable information back into the file.

The overwrite module 406 may modify the file to secure the personally identifiable information by overwriting the file with data to make the file unrecoverable (e.g., completely unrecoverable). For example, the overwrite module 406 may write over the file with all zeros, all ones, a predetermined pattern (e.g., alternating ones and zeros), and/or dummy data (e.g., randomized ones and zeros). As another example, the overwrite module 406 may use a multi-pass pattern write obliteration to overwrite the file. The overwrite module 406 may overwrite the file in response to a user initially performing a permanent deletion of a file (e.g., bypassing a temporary deletion) and/or deleting a file from a temporary deletion location (e.g., recycle bin, trash, etc.). The overwrite module 406 may include a user setting that, in response to permanent deletion of a file and/or deletion of a file from a temporary deletion location, overwrites the file and/or the overwrite module 406 may prompt a user to determine whether the user would like to overwrite the file. In some embodiments, only files that are tagged as containing personally identifiable information are modified by overwriting the file. In some embodiments, the overwrite module 406, in response to determining that the file likely contains personally identifiable information, permanently delete the file so that the file is unrecoverable.

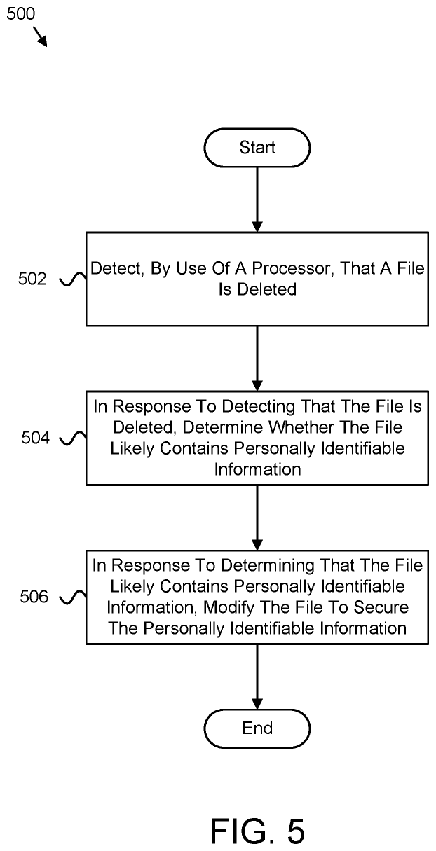

FIG. 5 is a schematic flow chart diagram illustrating an embodiment of a method 500 for securing personal information in a file. In some embodiments, the method 500 is performed by an apparatus, such as the information handling device 102. In other embodiments, the method 500 may be performed by a module, such as the file handling module 104. In certain embodiments, the method 500 may be performed by a processor executing program code, for example, a microcontroller, a microprocessor, a CPU, a GPU, an auxiliary processing unit, a FPGA, or the like.

The method 500 may include detecting 502, by use of a processor (e.g., the processor 202), that a file is deleted. In certain embodiments, the deletion detection module 302 may detect 502 that the file is deleted. In some embodiments, the file is a computer file. In various embodiments, the file is deleted by moving the file to a recoverable location. In certain embodiments, the file is deleted by permanently deleting the file.

The method 500 may include, in response to detecting that the file is deleted, determining 504 whether the file likely contains personally identifiable information. In some embodiments, the information identification module 304 may determine 504 whether the file likely contains personally identifiable information. In various embodiments, the personally identifiable information includes information usable to identify a person. In certain embodiments, determining 504 whether the file likely contains personally identifiable information includes searching the file for data resembling personally identifiable information.

The method 500 may include, in response to determining that the file likely contains personally identifiable information, modifying 506 the file to secure the personally identifiable information, and the method 500 may end. In some embodiments, the file modification module 306 may modify 506 the file to secure the personally identifiable information. In various embodiments, modifying 506 the file to secure the personally identifiable information includes encrypting at least a portion of the file. In certain embodiments, modifying 506 the file to secure the personally identifiable information includes replacing the personally identifiable information with non-personally identifiable information. In some embodiments, the non-personally identifiable information includes empty values. In various embodiments, the non-personally identifiable information includes reference data that facilitates restoring the personally identifiable information into the file. In certain embodiments, modifying 506 the file to secure the personally identifiable information includes overwriting the file with data to make the file unrecoverable. In some embodiments, the method 500 may, in response to determining that the file likely contains personally identifiable information, permanently delete the file so that the file is unrecoverable.

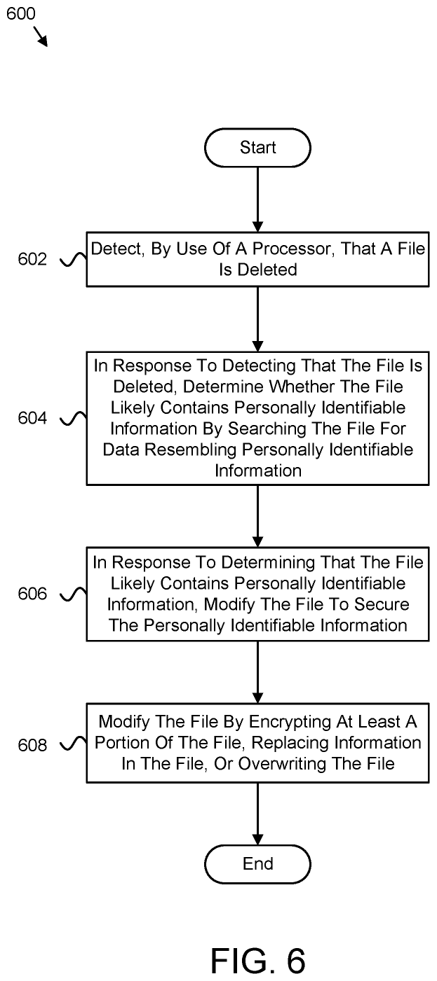

FIG. 6 is a schematic flow chart diagram illustrating another embodiment of a method 600 for securing personal information in a file. In some embodiments, the method 600 is performed by an apparatus, such as the information handling device 102. In other embodiments, the method 600 may be performed by a module, such as the file handling module 104. In certain embodiments, the method 600 may be performed by a processor executing program code, for example, a microcontroller, a microprocessor, a CPU, a GPU, an auxiliary processing unit, a FPGA, or the like.

The method 600 may include detecting 602, by use of a processor (e.g., the processor 202), that a file is deleted. In certain embodiments, the deletion detection module 302 may detect 602 that the file is deleted. In some embodiments, the file is a computer file. In various embodiments, the file is deleted by moving the file to a recoverable location. In certain embodiments, the file is deleted by permanently deleting the file.

The method 600 may include, in response to detecting that the file is deleted, determining 604 whether the file likely contains personally identifiable information by searching the file for data resembling personally identifiable information. In some embodiments, the information identification module 304 may determine 604 whether the file likely contains personally identifiable information. In various embodiments, the personally identifiable information includes information usable to identify a person.

The method 600 may include, in response to determining that the file likely contains personally identifiable information, modifying 606 the file to secure the personally identifiable information. In some embodiments, the file modification module 306 may modify 606 the file to secure the personally identifiable information.

The method 600 may include modifying 608 the file by encrypting at least a portion of the file, replacing information in the file, or overwriting the file, and the method 600 may end. In some embodiments, the file modification module 306 may modify 608 the file by encrypting at least a portion of the file, replacing information in the file, or overwriting the file. In various embodiments, modifying 608 the file by encrypting at least a portion of the file, replacing information in the file, or overwriting the file includes encrypting at least a portion of the file. In certain embodiments, modifying 608 the file by encrypting at least a portion of the file, replacing information in the file, or overwriting the file includes replacing the personally identifiable information with non-personally identifiable information. In some embodiments, the non-personally identifiable information includes empty values. In various embodiments, the non-personally identifiable information includes reference data that facilitates restoring the personally identifiable information into the file. In certain embodiments, 608 the file by encrypting at least a portion of the file, replacing information in the file, or overwriting the file includes overwriting the file with data to make the file unrecoverable. In some embodiments, the method 600 may, in response to determining that the file likely contains personally identifiable information, permanently delete the file so that the file is unrecoverable.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a memory that stores code executable by the processor to:
detect, by use of the processor, that a file is deleted;
in response to detecting that the file is deleted, determine whether the file likely contains personally identifiable information; and
in response to determining that the file likely contains personally identifiable information, modify the file to secure the personally identifiable information.

2. The apparatus of claim 1, wherein the file is deleted by moving the file to a recoverable location.

3. The apparatus of claim 1, wherein the code executable by the processor, in response to determining that the file likely contains personally identifiable information, permanently deletes the file so that the file is unrecoverable.

4. The apparatus of claim 1, wherein the code executable by the processor modifies the file to secure the personally identifiable information by replacing the personally identifiable information with non-personally identifiable information.

5. The apparatus of claim 1, wherein the code executable by the processor determines whether the file likely contains personally identifiable information by searching the file for data resembling personally identifiable information.

6. A method comprising:
detecting, by use of a processor, that a file is deleted;
in response to detecting that the file is deleted, determining whether the file likely contains personally identifiable information; and
in response to determining that the file likely contains personally identifiable information, modifying the file to secure the personally identifiable information.

7. The method of claim 6, wherein the file is a computer file.

8. The method of claim 6, wherein the file is deleted by moving the file to a recoverable location.

9. The method of claim 6, wherein the file is deleted by permanently deleting the file.

10. The method of claim 6, wherein the personally identifiable information comprises information usable to identify a person.

11. The method of claim 6, wherein modifying the file to secure the personally identifiable information comprises encrypting at least a portion of the file.

12. The method of claim 6, wherein modifying the file to secure the personally identifiable information comprises replacing the personally identifiable information with non-personally identifiable information.

13. The method of claim 12, wherein the non-personally identifiable information comprises empty values.

14. The method of claim 12, wherein the non-personally identifiable information comprises reference data that facilitates restoring the personally identifiable information into the file.

15. The method of claim 6, wherein modifying the file to secure the personally identifiable information comprises overwriting the file with data to make the file unrecoverable.

16. The method of claim 6, wherein determining whether the file likely contains personally identifiable information comprises searching the file for data resembling personally identifiable information.

17. A program product comprising a computer readable storage medium that stores code executable by a processor, the executable code comprising code to perform:
detecting, by use of the processor, that a file is deleted;
in response to detecting that the file is deleted, determining whether the file likely contains personally identifiable information; and
in response to determining that the file likely contains personally identifiable information, modifying the file to secure the personally identifiable information.

18. The program product of claim 17, wherein the executable code further comprises code to perform modifying the file to secure the personally identifiable information by encrypting at least a portion of the file.

19. The program product of claim 17, wherein the executable code further comprises code to perform modifying the file to secure the personally identifiable information by replacing the personally identifiable information with non-personally identifiable information.

20. The program product of claim 17, wherein the executable code further comprises code to perform, in response to determining that the file likely contains personally identifiable information, permanently deleting the file so that the file is unrecoverable.
